(19) United States
(12) Patent Application Publication
(10) Pub. No.: US 2026/0048938 A1
(43) Pub. Date: Feb. 19, 2026

(54) SORTING DEVICE

(71) Applicant: MARTISTEL INNOVATION FZCO, Dubai (AE)

(72) Inventors: Oleg SULTANOV, Moscow (RU); Sergey RAZUMOV, Strovolos (CY)

(21) Appl. No.: 18/992,981

(22) PCT Filed: Jul. 12, 2023
(86) PCT No.: PCT/EP2023/069317

§ 371 Date: Jan. 10, 2025

(30) Foreign Application Priority Data
Jul. 13, 2022 (EP) 22184647.0

(51) Int. Cl. B65G 1/04; B07C 5/38; B65G 60/00

(52) U.S. Cl. CPC B65G 1/0471; B07C 5/38; B65G 60/00

(57) ABSTRACT

The invention relates to a system for storing and organizing materials, comprising: —a storage system; at least a first layer, which comprises a plurality of storage places, which are preferably arranged in rows in two horizontal directions perpendicularly to each other and are used to receive boxes in stacks; at least one transport device, which has a receiving region for individual boxes or stacks of boxes for or from the storage system; a transport system, more particularly a rail assembly, on which the at least one transport device is mounted for movement to and within the storage system and for advancement for the purpose of individually stacking boxes; and a resorting device having at least one gripper, the resorting device being connected to the storage system via the transport system and being designed to receive a subset of boxes or all boxes of a stack of boxes from the transport device, to lift the received boxes and to transfer them to the transport device or to an additional transport device.

The present invention relates to a resorting device according to claim 1.

For a better understanding of the nature of the proposed technical solution, the following is a description of a specific implementation example, which is not a limiting example for the practical implementation of an automatic system for storing materials and collecting sets thereof.

JP S63 71026 A discloses a device designed to keep the number of breeding boxes to be stacked constant. A sensor is installed that detects when the number of these breeding boxes has reached an integer multiple of the preset value, and controls the operation of a transverse conveying mechanism for these successively fed breeding boxes.

As a significant difference from the present invention, it should be noted that breeding boxes are guided over a conveyor belt, which equips the boxes with soil, water and seeds. Subsequently, the individual trays on the conveyor belt (5) are stacked again via a lifting mechanism (10) in the same order as they arrived on the conveyor belt (5), and are transferred stack by stack via a downwardly open shelf (12) to a transport device (13), whereby a holding pair (12a) transfers the boxes in the shelf through the said opening to the transport device. The stack does not undergo any resorting in this process. Likewise, the holding pair 12a is not designed to receive boxes from the transport device 13 and return them to it. Furthermore, JP S63 71026 A does not have two independently operating grippers, each of which is designed to independently pick up boxes from the transport device and return them to it, thereby realizing the resorting according to the present invention. In addition, there is no deposit area provided over which stacks of boxes located on the transport device can be fed to the grippers by a vertical movement in order to then be taken over by the grippers.

JP H07 291455 A teaches a possibility for a small motor, which exerts a low torque, to serve for exchanging containers by providing a bearing element that works with a liquid pressure, and providing a pressure control means to constantly control the liquid pressure of the bearing part in conjunction with the movement of a vertical frame, so that the weights of the vertical frame, a horizontally moving element and a holding element are supported.

CN 111 153 220 B discloses a stacking mechanism for palletizing packaging boxes and belongs to the field of packaging and processing machines. A stack container feed bracket, a stack container stacking bracket, and a stack container unloading bracket of the stacking mechanism are arranged sequentially and firmly in the horizontal conveying direction of the packaging boxes, a plurality of rotating rollers for front box transport are connected sequentially and rotatably to the position of a front box transport bracket on the top of the stack container feed bracket in a horizontal direction, a lifting adjustment mechanism, a box clamping and fixing mechanism, and a stack container lifting mechanism are arranged sequentially and firmly on the stack container stacking bracket in a vertical direction from top to bottom, and multiple rear box conveying rollers are connected sequentially and rotatably to the position of a rear box conveying bracket in a horizontal direction on the top of the stack container unloading bracket. The stacking mechanism is sensibly constructed, packaging boxes of various sizes and specifications can be efficiently and stably stacked in succession, the operation is reliable, the stacking performance and quality of the packaging boxes can be ensured, the degree of automation of packaging box stacking is increased, and production requirements are met.

The claimed invention is explained in more detail with reference to the accompanying drawings. They show:

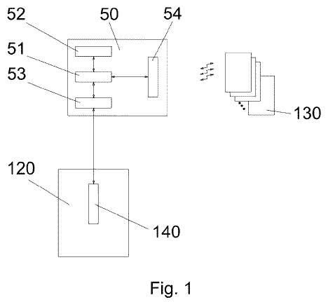

FIG. 1 a general diagram of an automatic system,

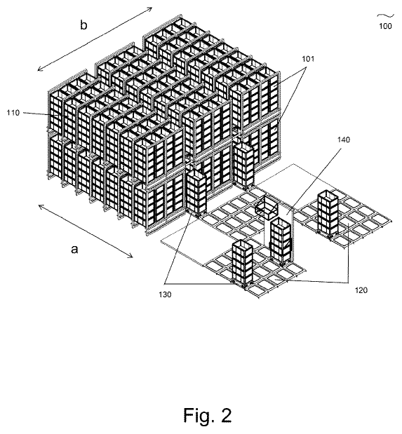

FIG. 2 an automatic system, front view, perspective view,

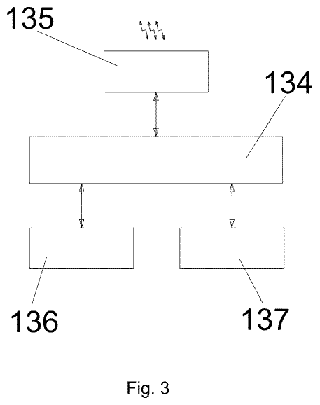

FIG. 3 a schematic diagram of a mobile transport device,

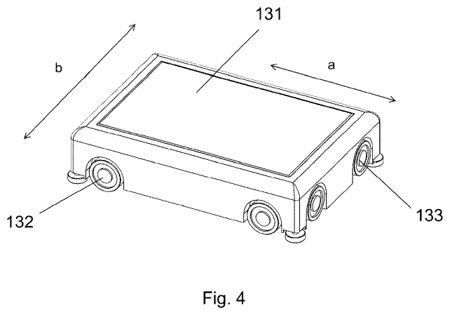

FIG. 4 a general view of a mobile transport device,

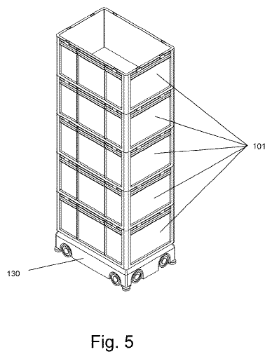

FIG. 5 a mobile transport device with a stack of trays on board,

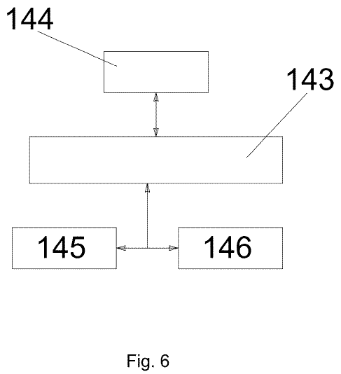

FIG. 6 a schematic diagram of a device for lifting stacks of trays,

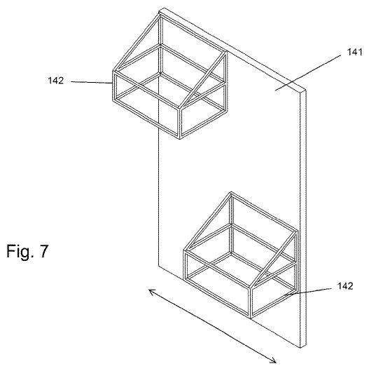

FIG. 7 a device for lifting stacks of trays, general view,

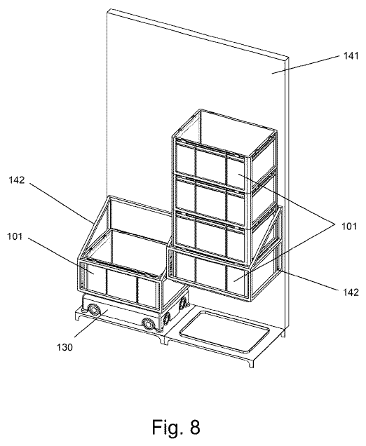

FIG. 8 a device for lifting stacks of trays interacting with stacks of trays and a mobile transport device,

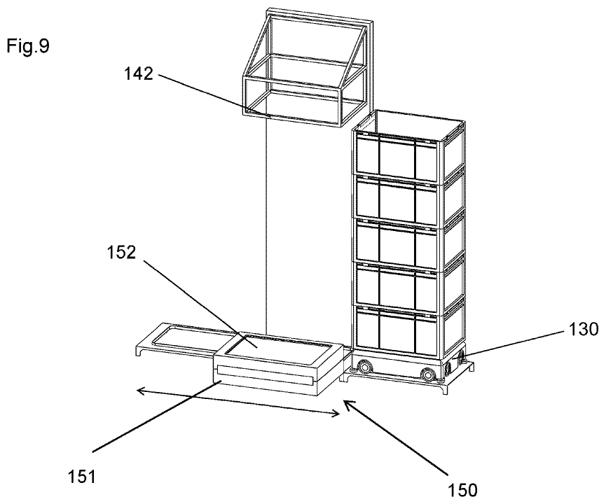

FIG. 9-11 an alternative embodiment with a gripper and a movable deposit area/deposit device, which can replace the second gripper with an advantageous movement sequence

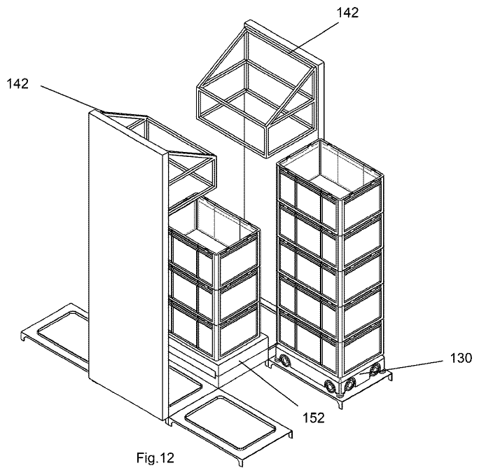

FIG. 12 a combination of the first and second embodiment, i.e., with at least one additional gripper and at least one movable deposit area/deposit device,

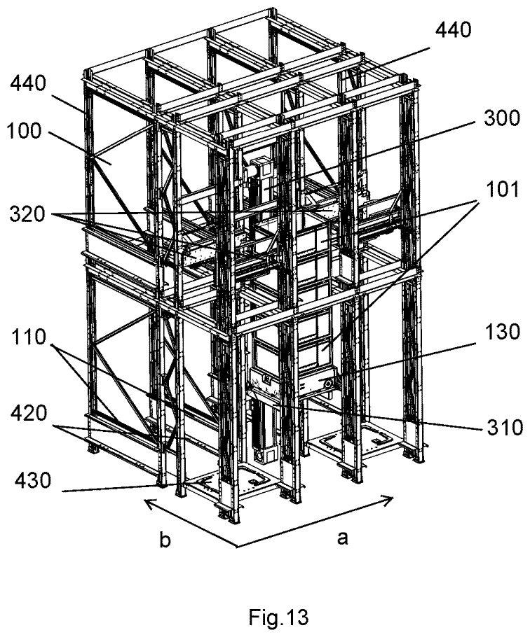

FIG. 13 shows an automatic device for resorting a stack of trays. Perspective view,

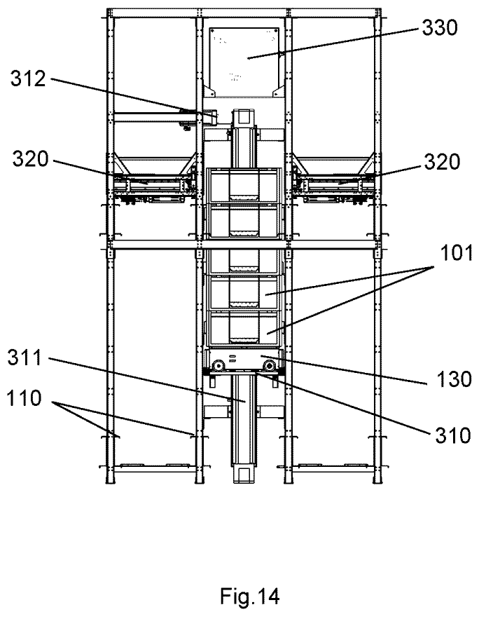

FIG. 14 shows an automatic device for resorting a stack of trays. Front view,

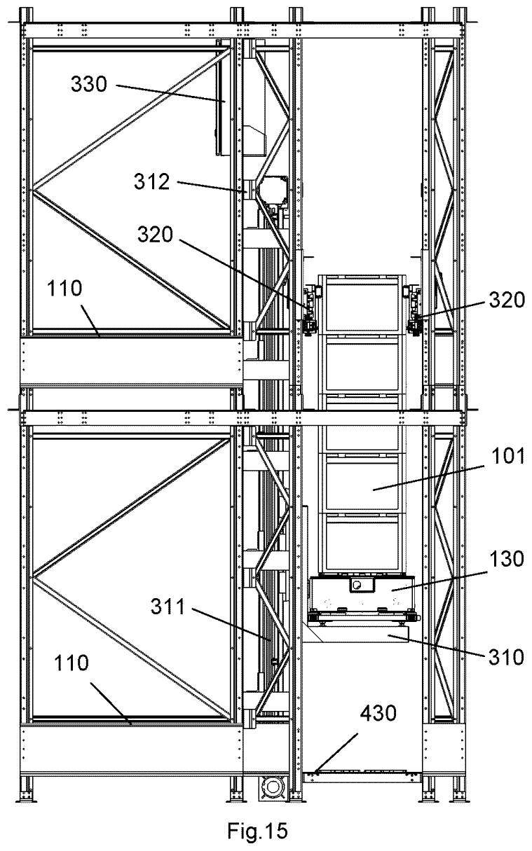

FIG. 15 shows an automatic device for resorting a stack of trays. Side view,

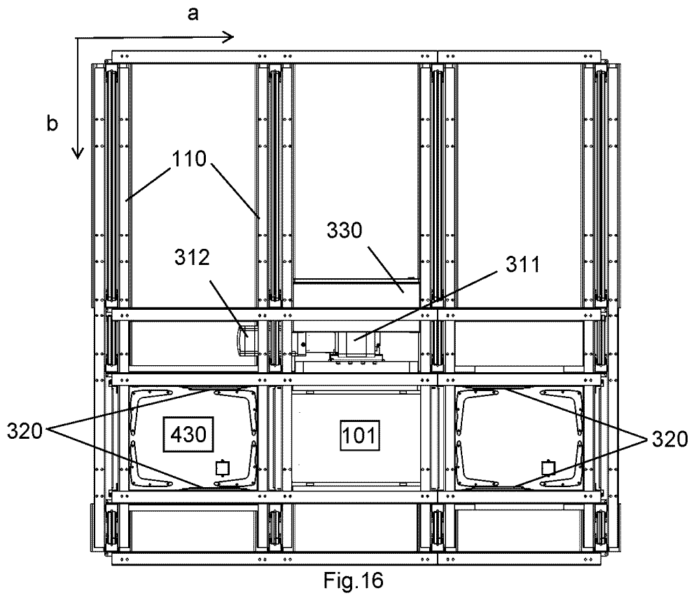

FIG. 16 shows an automatic device for resorting a stack of trays. Top view,

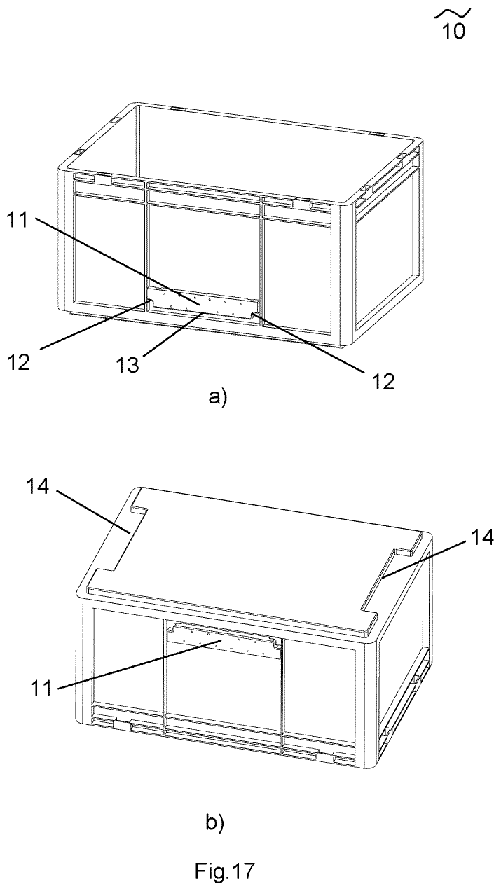

FIG. 17 shows a tray used in the system. Two perspective views: top left and bottom right,

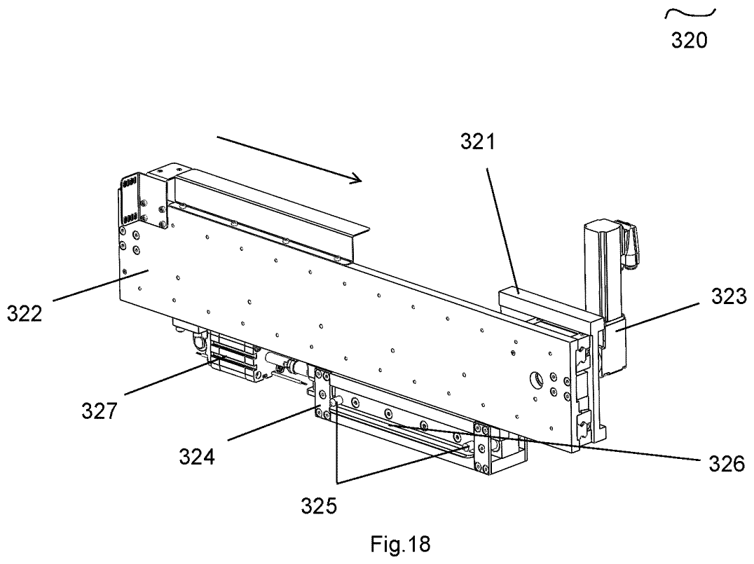

FIG. 18 shows a gripper of a pair in its original state. Perspective view and

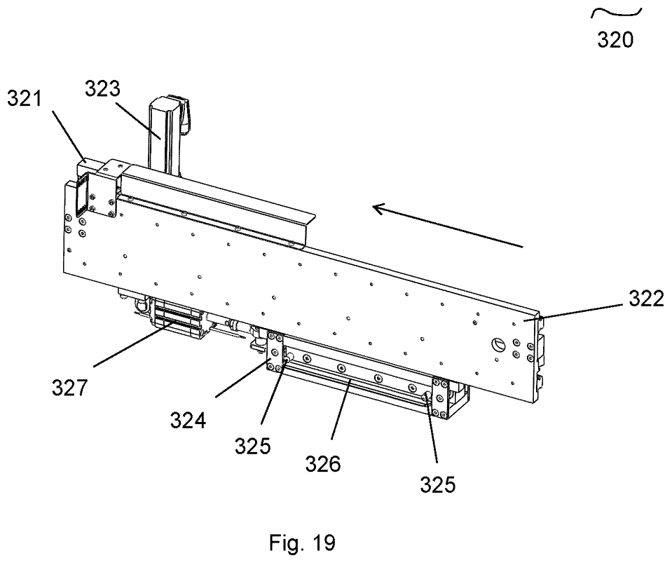

FIG. 19 shows one of the two grippers in its extended state. The view is perspective.

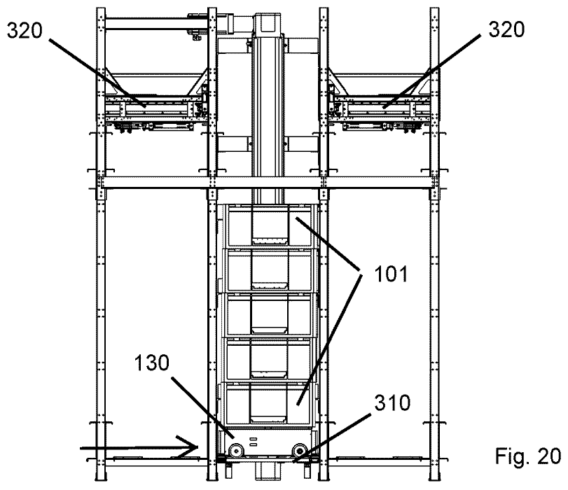

FIG. 20-31 show steps in the process of aligning a stack of trays (101) that are fed to a resorting device (310, 320) on a transport device (130).

As shown in FIGS. 1 and 2, the automatic box storage system and/or the organization system preferably comprises a control module 50 and/or a storage system 110 and/or a box/tray sorting area 120. The control module 50 comprises a central control processor 51 and/or an order processing unit 52 and/or an interface 53 and/or a wireless interface 54, preferably to the device 120 and/or 140. According to the present invention, the terms trays, boxes, tray and tablet can be used synonymously as the medium to be transported by the mobile transport device 130.

Several mobile transport devices 130 can be controlled via a wireless interface 54 by a central processor 50 and/or are provided to transport both empty and full boxes/trays as well as stacked boxes/trays/tablets 101 (FIG. 5) both within the storage system 110 and (and/or) in the sorting area of the trays 120 as well as between the mentioned areas.

As shown in FIG. 2, at least one, preferably at least two devices for lifting 140/142 stacks of boxes/trays/tablets 101 are present in the box/tray sorting area 120. In particular, the device 140/142 can be designed to lift boxes/trays from a transport device, preferably in the sorting area. Either all boxes/trays or a subset of boxes/trays can be lifted or picked up from the transport device. Additionally, the box/tray sorting area 120 may contain several buffer spaces to accommodate multiple TMUs 130 or their boxes if they arrive early and are waiting for further processing.

The trays within the storage system 110 are stored in stacks of preferably n trays on top of each other, in a special case n>=5, as shown in the figures.

As in FIG. 2, the storage area of stacked trays 110 can be designed with multiple levels with several separate stacks 110 on top of each other.

The transport device 130 shown in FIG. 3-5 preferably comprises a lifting table 131, which is designed to pick up and transport trays/boxes 101 or stacks of trays/boxes thereof, and two groups of drive wheels 132 and 133, which are intended to move the device in two horizontal directions perpendicular to each other.

The constructive design of the TMU 130 or the storage facility 110 is such that an empty/unloaded device 130 with its lifting table 131 without trays/boxes placed/transported on it can move freely underneath the stacks in the storage area 110. This allows the TMU to also be delivered to stacks located in areas further back in the storage area without having to take a detour around the storage area itself.

The mobile transport device 130, which is preferably part of the inventive storage and sorting system, can be controlled in any known manner. In particular, an embedded (industrial) control 134 with a wireless interface 135 for communication with the central processor 51 of the automatic system can be used for control. The control 134 controls the drivers 136 of the drives of the wheels 132 and 133 for movement, preferably along rails, in preferably two directions in a plane and/or the driver 137 of the vertical position of the wheels 132, 133, via which the wheels can be lifted and thereby the underside of the lifting table can touch the ground and/or the state of the lifting table 131 (height adjustability). The rails can be present in the storage area 110 and/or in the sorting area, thus also connecting between the areas, and can be provided as a basis for the movement of the transport devices 130.

FIGS. 6 to 8 show a device 140 for lifting individual or stacks of boxes/trays with a (base) body 141 and at least two grippers 142, which move vertically relative to the body 141 and enable the gripping/picking up and lifting of any number of boxes/trays 101 from or onto a TMU 130 in the operating area of the grippers 142. Preferably, the TMU is located below the gripper for picking up/gripping the boxes/trays by a gripper. The gripper can be provided with a frame that is dimensioned so that it can be placed over a stack of boxes. The grippers can be equipped with holding elements/holding lugs/holding brackets or other devices that can be adjusted to the trays/boxes, which are designed to hold boxes/trays 101 that are placed on the gripper (placed over, see e.g. FIG. 8) to the gripper 142.

The device for lifting stacks of trays 140 can also be controlled in any known manner. In particular, an embedded industrial control 143 can be used, which has an interface 144 for communication with the central processor 51 of the automatic storage system 100. Preferably, the control 143 controls the drivers 145 and 146 of the respective gripper drives 142 for picking up and lifting the (stacks of) tray(s)/box(es) 101 in the vertical direction.

FIG. 8 shows the interaction of the device 140 for lifting stacks of trays with trays/boxes 101 standing on the mobile transport device 130. As can be seen, the mobile transport device 130 first approaches the first (right) gripper 142 of the device 140, whereby the first gripper 142 in the present example is selected to lift the four upper boxes/trays 101 of the stack standing on the TMU 130.

Afterwards, the TMU 130 moves in a first horizontal direction under the second (left) gripper 142 of the device 140. Then the second gripper 142 lifts the (remaining) tray/box 101 from the TMU 130.

Subsequently, the TMU moves under the first gripper 142 of the device 140, whereby the first lifted stack of trays/boxes 101 is placed on the TMU 130. Then the TMU 130 moves again under the second (correspondingly lifted) gripper 142 of the device 140, which now places the previously bottom tray/box 101 of the stack on top of the stack. According to the present invention, the described and claimed “systems” can be devices and equipment.

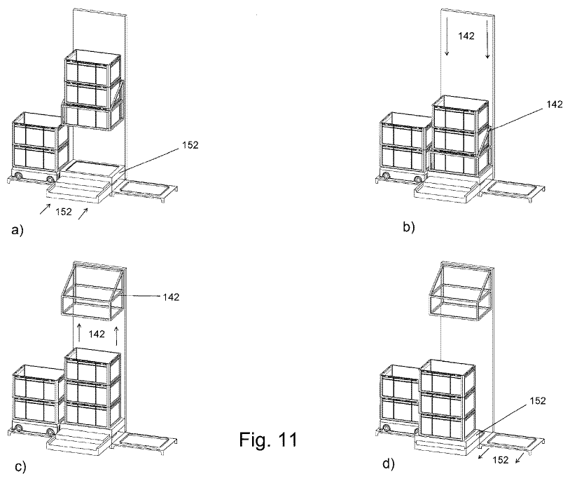

Alternatively or additionally, instead of a second gripper or in addition to it, a movable deposit area/deposit device can be provided near the gripper (FIG. 9-11). A movable part 152 of the deposit area/deposit device 150, for example a movable shelf or a (shiftable/relocatable) conveyor belt, can be movable towards the gripper 142, allowing the gripper to transfer picked up boxes to the deposit area/deposit device (e.g., place them on it—see FIG. 11b).

The deposit device can have a stationary base 151, on and/or against which the movable part 152 of the deposit device is movably mounted.

The movable deposit area/deposit device can then be moved away from the gripper (below the gripper) (FIG. 11c à 11d), thereby freeing up a loading area (below) the gripper, i.e., an area (FIG. 11d) in which a transport device 130 can be provided so that the gripper can take over its boxes or transfer them to it.

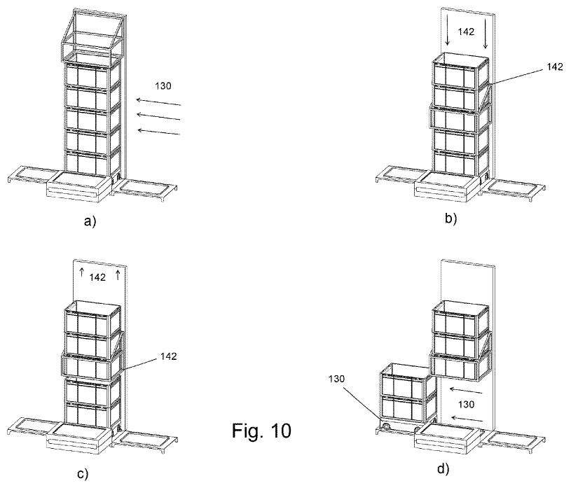

This enables the gripper to, for example, first take over one or more boxes from a transport unit (FIG. 10b à 11c), then transfer these to the deposit area/deposit device (FIG. 11a è 11b à 11c) and thereby be freed up for picking up further boxes. If an empty transport device is located next to/at the movable deposit area/deposit device and/or in the loading area of the gripper, the movable deposit area/deposit device can transfer the temporarily stored boxes (subset) back to the transport device. Alternatively, the deposit area/deposit device can transfer the boxes back to the gripper 142 at a given time, thus enabling an overall resorting of the boxes of one or more transport devices.

According to the present invention, resorting can particularly mean being able to change the order of boxes in an existing stack of boxes using the device according to the invention.

According to the present invention, a stack of boxes is preferably a set of at least two, preferably three, four, five or more boxes arranged on top of each other.

According to the present invention, a subset of boxes of a stack can be at least one box less than is present in the respective stack.

Subsequently, the transport device with the subset of boxes can be removed for further processing, or the additional boxes picked up by the gripper can be loaded onto the subset. This enables a resorting of boxes/a stack on a transport device using either at least two grippers or by at least one gripper in combination with the previously described mobile deposit area/deposit device. The present invention relates to a corresponding device as well as a corresponding method.

In principle, it is also conceivable to provide a combination of the first and second embodiments, as shown exemplarily in FIG. 12. This allows both an exchange of boxes as in the embodiment of FIG. 9-11, but additionally also an exchange of boxes between different transport devices 130 or the transfer of boxes from one transport device to a second.

A possible resorting using the embodiment according to FIG. 11 could, for example, proceed as follows:

A first transport device 130 is moved into an area below one of the two depicted grippers 142. This first gripper 142 takes over any number of boxes from the transport device 130. Subsequently, the first gripper 142 transfers the boxes or a subset of boxes to the movable part 152 of the deposit area/deposit device, which can be moved towards this first gripper for this purpose.

On the other side, at the second gripper 142, this gripper can now either take over the boxes from the deposit area/deposit device, which is moved towards the second gripper 142 for this purpose, or the gripper is already loaded with boxes, which the gripper can place on the stack of boxes of the deposit area/deposit device, as long as the deposit area/deposit device is moved towards the gripper. Subsequently, the gripper can again lift all boxes or a subset of the combined boxes and, after the deposit area/deposit device has been withdrawn from the loading area of the second gripper (together with the remaining boxes, if applicable), transfer the held boxes of the second gripper to a transport device 130, which is positioned in the loading area of the second gripper 142.

This enables a rearrangement between different transport devices 130 and/or a change in the order of boxes of a transport device 130.

FIG. 13 shows a section of the framework of a storage system 100, into which a stackable tray/box resorting device is integrated. In the shown representation, the storage system 100 preferably comprises shelf sections 440 with a plurality of storage locations 110, on which stacks of trays 101 are stored. The storage locations 110 of the storage system 100 are preferably arranged in two horizontal directions a and b perpendicular to each other, as well as in several vertical levels.

To enable the movement of the trays or tray stacks (box stacks) 101, rails 420 are provided below the storage locations 110, for example, which can be connected to each other in the passages between the sections 440 by rail crossings 430. The combination of the rail tracks 420 with the crossing tracks 430 can form a transport network on which the automatic mobile transport device 130 (TMU) is moved.

The mobile transport device 130 is designed to pick up or set down stacks of boxes/trays 101 between the storage locations 110 of the automatic storage system 100. The mobile transport device 130 can move along the transport network in two perpendicular horizontal directions a and b.

The box stack resorting device 300 is also shown in FIG. 13. In the shown representation, it has a loading area 310 with a vertically movable deposit area and two gripper(pairs) 320, which are preferably arranged in a horizontal plane of the storage system 100 on two/both sides of the movable deposit area of the loading area 310, preferably at the crossing points 430.

As shown in FIGS. 13-16, the loading area 310 of the resorting device consists of a slider/deposit area 310, which preferably moves vertically along a column 311 and can be driven by an electric drive 312. In its lower position, the deposit area of the loading area 310 can be aligned with the transport network of a lower storage level. The upper working surface of the loading area 310 preferably follows the geometry of the adjacent rail crossings 130, so that the TMU 130 can move towards or away from it in both the first horizontal direction (along the passage to the adjacent crossings 130) and in the second horizontal direction (in which the vertical column 311 is not present). In addition, a battery charger (not shown in the figures) can be mounted on the deposit area of the loading area 310, which charges the batteries of the TMU 130 during the entire time it is on the deposit area of the loading area.

The vertical movement of the deposit area of the loading area 310 in the embodiment shown in the figures allows the TMU 130 to be moved empty or with a stack of trays 101 on it between a first and a second storage level. That is, by aligning the deposit area of the loading area 310 with the transport network of the second storage level, the TMU 130 can enter or exit in the same (three) directions as in the first storage level.

The gripper(pairs) 320 of the automatic box stack sorting device 300 are arranged so that they can grip any number of trays 101 of the stack standing on the TMU (1, 2, 3, 4 or (all) 5 trays of the stack, as shown in the example in the figures) when the TMU 130 is moved onto the deposit area of the loading area 310.

The two gripper(pairs) 320 of the automatic box stack sorting device 300 are preferably equivalent and have the same functionality. The order in which they work depends preferably only on the software that controls the operation of the device 300 and which is preferably located in the control cabinet 330.

As can be seen in FIG. 15, the gripper pairs 320 are preferably arranged above a second storage level so that the TMU 130, empty or with a stack of trays 101, can pass through the area of gripper access 320 to the stack of boxes on the TMU in the first horizontal direction. To allow the TMU 130 to pass in this way, each gripper pair 320 preferably has its own drive elements.

FIG. 17 shows two views of a variant of the tray 101 used in this system. View 17a shows a perspective view of the tray 101 from the top left and view 17b from the bottom right. As shown in both views, support strips 11 are preferably located on both longitudinal sides of the tray for removing the tray 101 from the stack. The support strips can serve to center the trays 101 against the grippers 320 during removal and to bear the weight of the removed trays. For centering, the carrier strips 11 preferably have a pair of recesses 12 into which the elements of the grippers 320 penetrate before removal, and for load removal, preferably a lower edge 13 that rests on a corresponding gripper pad during removal.

As shown in FIG. 17b, the underside of the tray 101 preferably has recesses 14 to center and hold the bottom tray 101 of the stack of the TMU 130 when it is removed and transported.

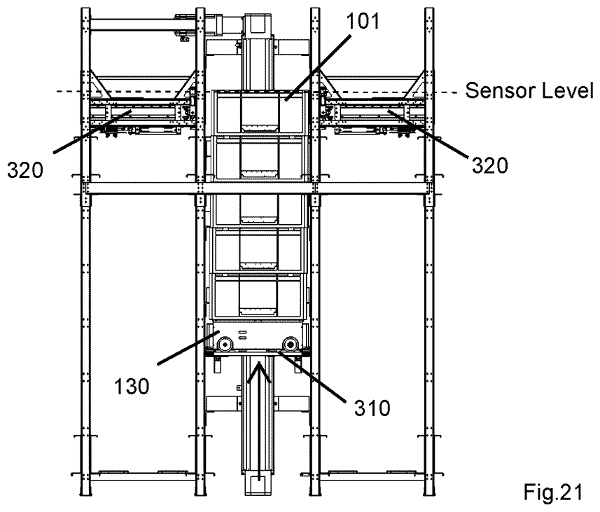

FIGS. 18 and 19 show an embodiment of one of the grippers 320 of the gripper pair. FIG. 18 shows the gripper 320 in its original/retracted state (holding position) when the gripper is in its positioning zone. In this position, the box or multiple boxes can be temporarily stored on the gripper. In FIG. 21, a movable part of the gripper 320 is extended into the working area/pickup position of the loading area. The working area can be within the vertical channel in which the deposit area of the loading area 310 moves up and down.

In FIGS. 18 and 19, it can be seen that each gripper 320 can have a stationary base 321 and a module 322 movable relative to it, which can be moved by an electric drive 323. On the underside of the movable module 322, a clamp 324 with two centering fingers 325 and a support pad 326 is preferably attached. The centering fingers 325 and the support pad 326 are preferably extended from the shadow of the movable module 322 by an actuator 327, which is also attached to the bottom of the movable module 322 and moves with it. The second gripper 320 of the pair can mirror the gripper shown in the figure.

The automatic stack container resorting device described above operates according to the following algorithm:

The TMU 130 with the tray stack 101 moves onto the working surface/deposit device of the loading area 310, which stands in its lower position at the level of the transport network of a first storage level of the system.

The deposit device of the loading area 310, which can also be referred to as a lifting carriage, on which the TMU 130 with the box stack 101 stands, is raised to a height of the grippers to pick up the desired number of upper boxes 10 of the stack. The deposit device stops.

A gripper pair 320 is moved from its original/retracted position into their working area of the deposit device of the loading area 310. After moving the movable modules 322 of a gripper pair 320, the clamps 324 are preferably brought into the position for picking up the tray 10 using their actuators 327. The centering pins 325 of the clamps 324 can fall into the recesses 12 of the support strips 11 of the tray 10, and the support pads 326 can be positioned under the lower edge 13 of the tray 10.

Then the carriage is lowered slightly (preferably by 30-50 mm), the desired box (or stack of boxes) is lowered onto the support surfaces 326 of the gripper pair 320, thereby separating the box(es) from the remaining stack on the TMU 130. Afterwards, the pair of movable modules 322/grippers with the tray 101 (or tray stack) gripped by them is returned to its original state (original/retracted position).

Then the carriage/deposit device moves to the height required to pick up the desired box 101 of the stack standing on the MTU 130. The deposit device/(lifting)carriage stops.

Then the second (pair of) gripper(s) 320, in the same way as described in the paragraphs above, picks up the desired box(es) 101 from the stack and moves it/them to the second side of the working area of the loading area 310 (original/retracted position of the second gripper(pair)).

Afterwards, the first gripper(pair) 320 / its movable modules 322 with the removed box(es) 101 (or trays) moves into the working area of the deposit device of the loading area 310. The deposit device of the loading area 310 can be raised by 30-50 mm, and/or the weight of the box 10 transferred from the two grippers 320 to the stack standing on the TMU 130. The clamps 324 of the grippers 324 can be brought to their initial state by the actuators 327, and the already empty movable modules 322 of the grippers 320 themselves can then be brought to their initial state and leave the working area of the grippers or the deposit device of the loading area 310.

The deposit device of the loading area 310 moves vertically into the position where the box 101 is placed on top of the stack of trays standing on the TMU 130, i.e., down far enough for the second gripper to transport its carried boxes back into the working area and onto the stack of boxes. The deposit device stops.

The second gripper pair 320 moves its movable modules 322 with the originally picked up box(es) 101 into the working area of the deposit device of the loading area 310 or the gripper pair. The carriage 310 / deposit device of the loading area 310 raises by 30-50 mm and transfers the weight of the boxes 101 from the second gripper(pair) 320 to the stack of boxes standing on the TMU 130. The gripper clamps 324 can be brought to their initial state by the actuators 327 and the already empty movable modules 322 of the grippers 320 themselves can then be brought to their initial state and leave the working area of the lifting carriage 310.

The resorting process is completed by vertically moving the lifting carriage/loading area 310 to the desired storage level (e.g. first or second), after which the TMU 130 with the resorted stack of boxes 101 is moved in one of the possible directions in the transport network of the storage system to carry out further operations as part of the automatic storage system.

It should also be understood that the previously described algorithm for the operation of the automatic stack resorting device is not the only possible one, but only describes one of the most common special cases of the device operation of the resorting device in the system, when any box in its stack should be placed on top. The working area can also be referred to as the pickup position of the grippers. The retracted position can also be referred to as the holding position.

In addition to the already described functions (310, 320), namely resorting the stack of trays (101) and moving the transport unit (130) between storage levels, another function can be provided alternatively or additionally, which concerns the alignment of the relative positions of the boxes (101) in the stack to each other and/or to the MTU on which the boxes are located. The aim can be to align all boxes of the stack parallel to each other to ensure a particularly secure position of the boxes in the stack.

By stacking boxes on the MTU, relative displacements of the boxes to each other and/or to the MTU can occur. These are preferably to be compensated, especially before a resorting takes place. This can prevent boxes from falling out of the stack.

Thus, FIG. 20 shows the zero step operation of the resorting device (310, 320), in which the transport device (130) with the stack of boxes (101) moves to the lifting platform (310) of the device on the lower storage level of the system.

FIGS. 21-23 show the first step of the resorting device (310, 320), in which the lifting platform (310) with the transport device (130) with the stack of boxes (101) standing on it is moved to the height of a displacement of the stack of boxes, so that the plane of the sensors (340), which detect the relative displacement of the boxes to each other or of the boxes/stack of boxes to the MTU (130) or the deposit device of the loading area (310), is preferably 10-30 mm below the top of the uppermost box (101) of the stack. FIG. 21 shows in the side view the height of the deposit device (310) and where the plane of the sensors (340) can be located.

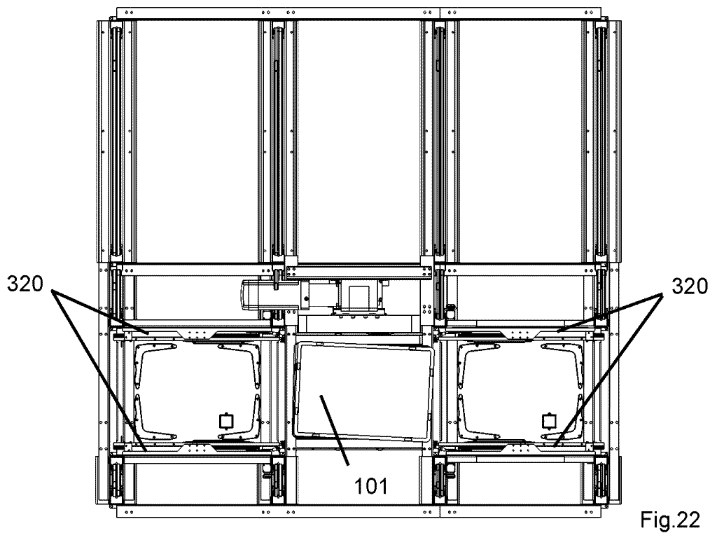

FIG. 22 shows in the top view the slipped stack of trays (101).

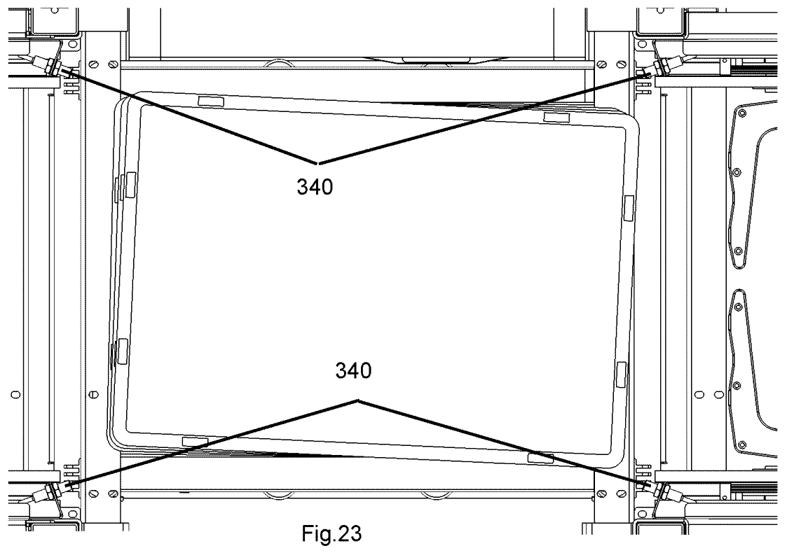

FIG. 23, an approximate top view, shows a slipped stack of boxes (101), or individual boxes slipped relative to each other, and one of the possibilities for arranging the sensors that determine the extent of slipping/rotation of the boxes (101) in the stack relative to each other or to the MTU. In the proposed variant, preferably 4 sensors are used, which for example measure the distance to 4 corners of the upper box (101). Depending on the difference of the measured distances, it is decided whether the stack of boxes or a single box needs to be aligned or resorted relative to the other boxes. It should also be understood that the number of sensors, their type and arrangement may differ from that proposed in the figure, the arrangement shown in the figure does not limit the invention in any way. Preferably, the sensors are arranged to detect an alignment deviating from a desired alignment relative to other boxes of the stack, the MTU and/or the deposit area.

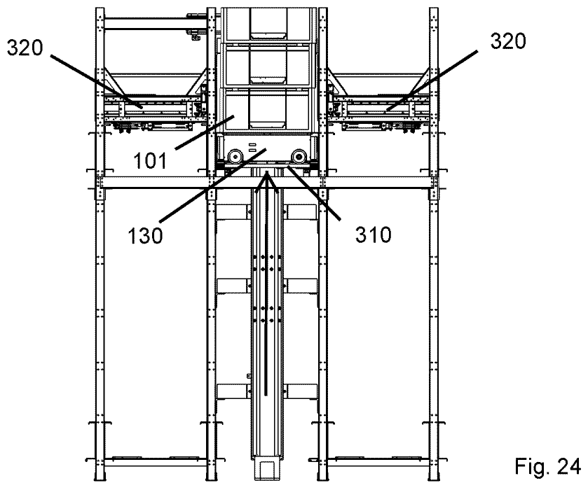

FIG. 24 shows a working step in which the boxes (101) in the stack are aligned. For this purpose, the lifting platform (310), as shown in the figure, can move the transport device (130) with the stack of boxes (101) standing on it into a position where one of the grippers (320) can grip the bottom box (101) of the stack.

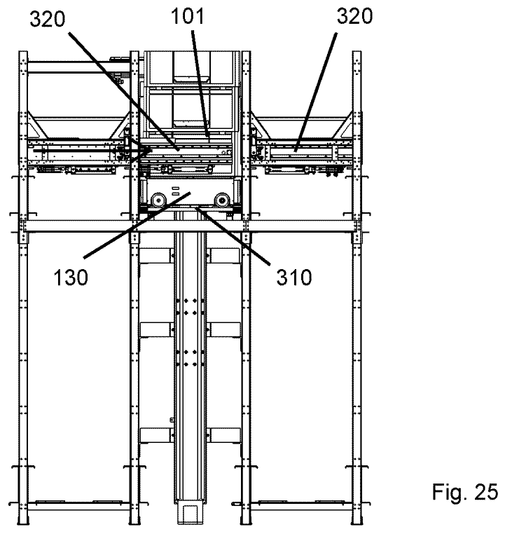

FIG. 25 shows in the side view the next step of aligning the stack of boxes (101), namely aligning the bottom box (101) of the stack, whereby a pair of grippers (320) is moved into the working area of the deposit area of the loading area (310).

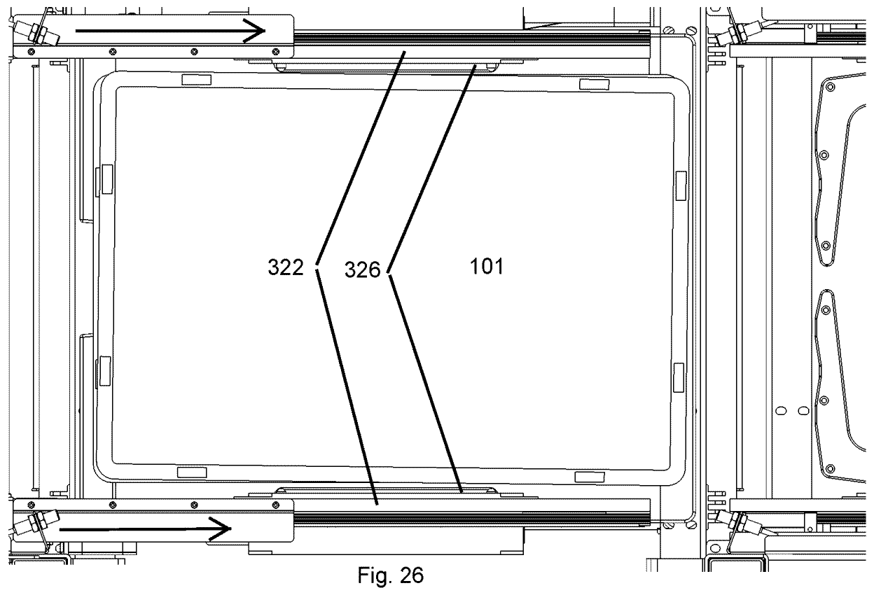

FIGS. 26 to 29 show in the top view the working steps of the gripper pair (320) that aligns the lower box (101) of the stack, preferably before the boxes are picked up by the grippers for resorting.

Thus, FIG. 26 shows a similar starting position as the device shown in FIG. 25, only in the top view, showing that the tray (101) is offset and skewed relative to the base surfaces.

In FIG. 25, the movable modules (322) of a gripper pair (320) are preferably extended into the working area of the lifting platform (310), preferably while the gripper clamps (324) and/or with the centering fingers (325) and/or the support pads (326) can be in their original state (in the shadow of the movable modules).

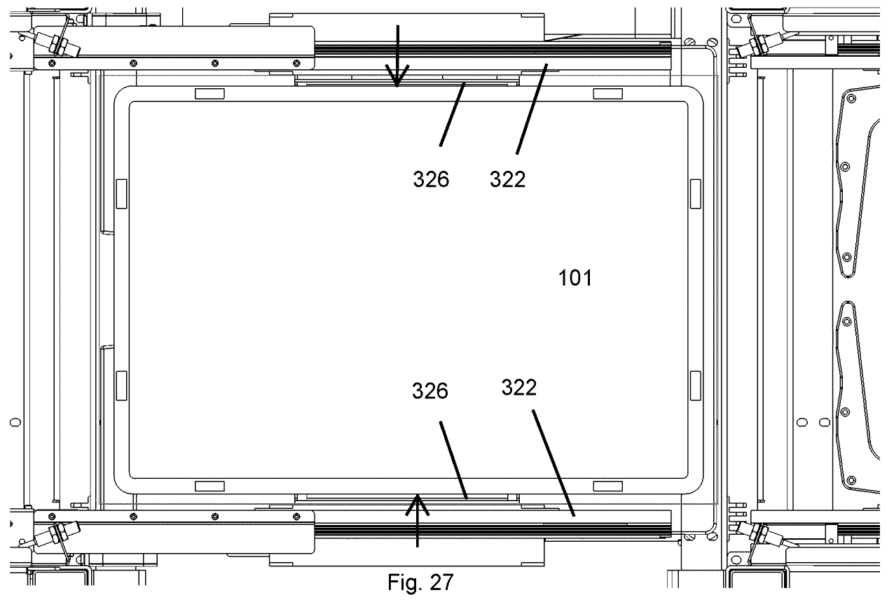

FIG. 27 shows the position in which the gripper clamps (324) can move their working elements centering fingers (325) and support pads (326) into the gripping position of the lower tray (101) of the stack and thereby align it.

The grippers can have laterally extendable elements which can be moved, preferably laterally, towards a box in the stack. Alternatively, the gripper itself can be movable laterally towards the boxes, By the contacting movement of the elements/the grippers to the box, it is aligned parallel to the grippers from a slipped/rotated position. The extendable elements can be the same elements that the grippers use to pick up or hold the box or boxes. A repeated application/movement of the elements/grippers to the individual boxes of the stack aligns the boxes parallel to each other.

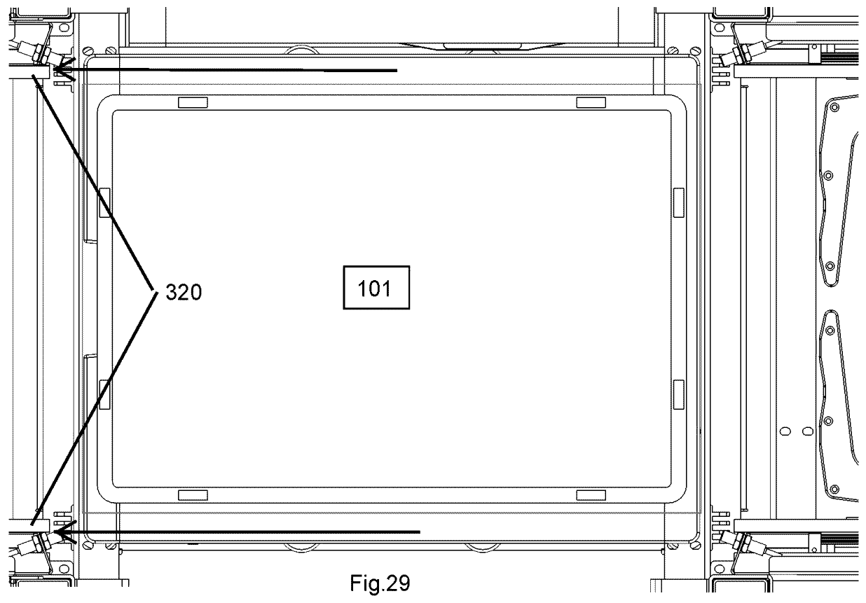

The position after aligning the bottom tray (101) of the stack is shown in FIG. 29. It can be seen that the gripper clamps (324) have brought their working elements centering fingers (325) and support pads (326) back to their original position in the shadow of the movable modules (322) and the bottom tray (101) of the stack is aligned after this process.

FIG. 29 shows the final position of the grippers (320) after aligning the bottom tray (101) of the stack, with the top view showing that the gripper pair (320) has withdrawn its movable modules (322) from the working area of the lifting platform (310).

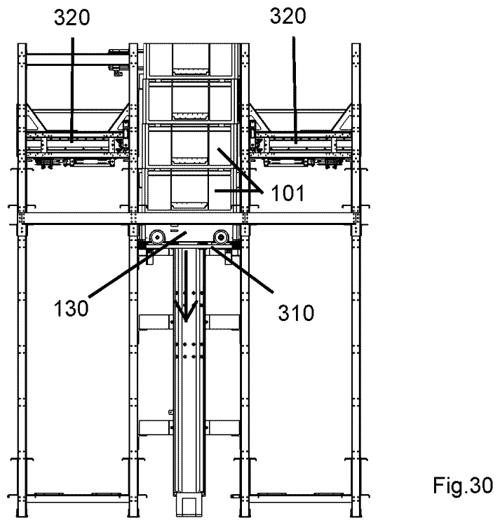

FIG. 30 shows the next working step of the resorting device (310, 320). The side view shows that the lifting platform (310) has moved down to the alignment plane of the second box (101) of the stack. The gripper is thus ready to align the second box from the bottom.

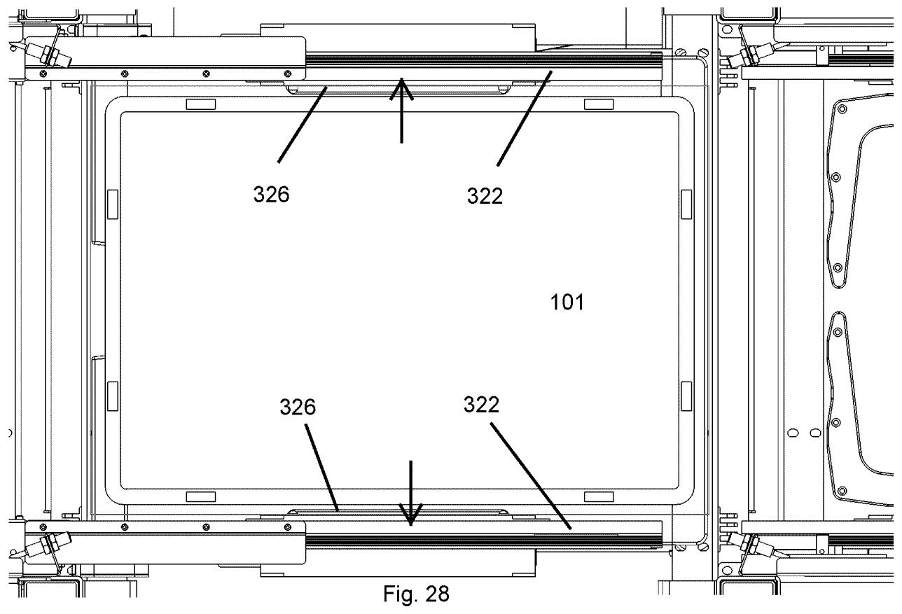

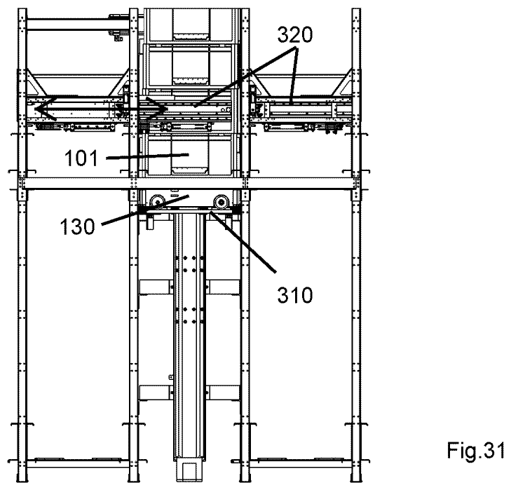

FIG. 31 shows a working step of the resorting device (310, 320), in which it aligns the second box (101) of the stack using a gripper pair (320) in a similar manner to the process shown in FIGS. 28-31.

According to the proposed method, the remaining boxes of the stack are then aligned successively from bottom to top, so that they are preferably aligned parallel to each other and/or parallel to the MTU and/or parallel to the deposit device as shown in FIG. 5. A control measurement of the position of the upper tray of the aligned tray stack (101) can be carried out and a decision made about the further tasks of the device (310, 320).

Alignment from bottom to top is in this case the only possible correct solution, since when aligning in a different order (e.g. any arbitrary middle tray or the top tray of the stack), the bottom of the aligned tray could jump out of the lower tray and the entire tray stack could be destroyed.

1. a system (100) for storing and organizing materials, comprising:
a storage area,
with a plurality of levels, each comprising multiple storage locations (110) that are preferably arranged in rows in at least one horizontal direction, preferably two horizontal directions perpendicular to each other, and serve to accommodate boxes (101) in stacks as storage locations for the materials,
at least one transport device (130), which has a receiving area (131) for individual boxes (101) or a stack of boxes (101),
a transport system, in particular a rail arrangement, along which the at least one transport device (130) is movable from and/or to and/or within the storage system(s) (100) and is provided to be movable to individual boxes or stacks of boxes in the storage system (100) for their pickup, and
a resorting device (310/320), in particular according to claim 7 with
a loading area (310), which is designed to take over a transport device (130) with or without box(es) (101) from the storage system (100), in particular via the transport system,
at least one first gripper (320) and one second gripper (320), which are designed to independently pick up and hold at least one, preferably at least two, particularly preferably any number/subset of boxes from a stack of boxes from the transport device (130) in the loading area (310), and are further designed to return the respectively picked up box(es) (101) to the transport device (130) located in the loading area (310) or another transport device (130) in the loading area (310),
a movable deposit device, which is provided in the loading area (310) or as part of it and is vertically movable to be accessible to the first and second gripper (320), and
that the first and second gripper (320) are movably mounted, preferably horizontally, between a retracted holding position, in which the at least one box can be temporarily stored on one of the grippers (320), and a pickup position presented to the deposit device, for picking up and depositing at least one box (101) from/to the deposit device.

2. A system for storing and organizing materials according to claim 1,
characterized in that
the first and second gripper (320) are arranged at a 90° or 180° angle to each other opposite the loading area.

3. A system for storing and organizing materials according to claim 1,
characterized in that
the first and second gripper (320) are arranged in a common horizontal plane.

4. A system for storing and organizing materials according to any one of claim 1,
characterized in that
the loading area (310) is horizontally aligned with the transport system in a starting position, thereby providing a transition of a transport device (130) from the transport system (420) to the loading area.

5. A system for storing and organizing materials according to claim 4,
characterized in that
the starting position is arranged above or below the pickup position for the grippers (320)

6. A system for storing and organizing materials according to any one of claim 1
characterized in that
the grippers (320) are designed to be laterally presented to a box in the loading area or have elements which can be laterally presented to a box in the loading area, whereby it can be picked up by the gripper (320) or aligned relative to a box underneath.

7. The resorting device, in particular for a storage system (100) according to claim 1, with
a loading area (310), which is designed to take over a transport device (130) with or without box(es) (101) in stacks from a storage system (100), in particular via a transport system, or from a transport system
at least one first gripper (320) and one second gripper (320), which are designed to independently pick up and hold at least one, preferably at least two, particularly preferably any number/subset of boxes from a stack of boxes from a transport device (130) in the loading area (310), and are further designed to return the respectively picked up box(es) (101) to the transport device (130) located in the loading area (310) or another transport device (130) in the loading area,
a movable deposit device, which is provided in the loading area (310) or as part of it and is vertically movable to be accessible to the first and second gripper (320), and
that the first and second gripper (320) are movably mounted, preferably horizontally, between a retracted holding position, in which the at least one box can be temporarily stored on one of the grippers (320), and a pickup position presented to the deposit device, for picking up and depositing at least one box (101) from/to the deposit device.

8. The resorting device according to claim 7
the grippers (320) are designed to be laterally presented to a box in the loading area or have elements which can be laterally presented to a box in the loading area, whereby it can be picked up by the gripper (320) or aligned relative to a box underneath.
